(19) United States
(12) Patent Application Publication
(10) Pub. No.: US 2006/0063039 A1
(43) Pub. Date: Mar. 23, 2006

(54) Information medium having magnetic element, information detection apparatus, information rewriting and detection apparatus and image forming apparatus

(75) Inventors: Shoji Yamaguchi, Nakai-machi (JP); Mario Fuse, Nakai-machi (JP); Kunihiro Takahashi, Nakai-machi (JP); Yasunori Koda, Nakai-machi (JP)

Correspondence Address: OLIFF & BERRIDGE, PLC, P.O. BOX 19928, ALEXANDRIA, VA, 22320, US

(73) Assignee: FUJI XEROX CO., LTD., Tokyo (JP)

(21) Appl. No.: 11/078,480

(22) Filed: Mar. 14, 2005

(30) Foreign Application Priority Data
Sep. 21, 2004 (JP) 2004-273458

(51) Int. Cl. G11B 5/66; G11B 21/04

(52) U.S. Cl. 428/826; 428/827; 360/81

(57) ABSTRACT

An information medium includes a magnetic member having one or plural magnetic elements and a substrate where the plural magnetic elements are arrayed at predetermined intervals in a predetermined direction, and a main body holding the magnetic member.

### BACKGROUND OF THE INVENTION

1. Field of the Invention The present invention relates to an information medium having magnetic elements and an information detection apparatus, and more particularly, to an information medium where plural magnetic elements are arrayed at predetermined intervals in a predetermined direction and an information detection apparatus.

2. Description of the Related Art

It is known to provide methods and apparatuses to address security problems such as an anti-counterfeit technology in unauthorized duplication of securities and the like. For example, a known method is to prepare securities or the like using special paper including a particular pattern or special ink containing an infrared ray absorbent or the like for the purpose of counterfeit prevention. In this method, when securities or the like generated with such special paper are duplicated by using a scanner, a copier or the like, the particular pattern as a latent image, special ink or the like included in the special paper is visibly printed as evidence of counterfeit. However, the method requires scanning or irradiation of the image of securities or the like, made of the special paper, with light from a predetermined direction so as to detect the particular pattern, special ink or the like included as a latent image in the special paper.

Further, another proposed method is to identify an article by measuring the intensity of reversed magnetic field of a magnetic element included in the article. A magnetic element which emits a hard-to-imitate signal is incorporated in a small portable terminal such as an IC card. When using the card, security is guaranteed by an inquiry made by application of an alternating field and identification using detection of the unique signal emitted from the magnetic element incorporated in the small portable terminal by abrupt magnetization reversal. For example, it is known to provide an article having an identification function such as a non-contact type IC card enabling non-contact identification using magnetism and an identification method for the article. Further, it is known to provide a method and an apparatus for exciting a magnetic marker which is attached to an article for identification of the type and volume of the article.

In the related art, an information medium where plural magnetic elements are arranged is placed in a magnetic field generation area around an excitation detection coil, and multi-bit detection is performed based on the difference in magnetization reversal pulse characteristics (width, generation interval) due to the directions and coercive forces of the respective magnetic elements. In this method, the information medium having the magnetic elements are placed within a detection apparatus, and at the same time, the difference in magnetization reversal pulse characteristics of the respective magnetic elements is detected. In some cases, however, detection cannot be appropriately performed due to degradation of characteristic by noise, distortion of information medium or the like. Accordingly, an accurate multi-bit information detection method is desired.

### SUMMARY OF THE INVENTION

The present invention has been made in consideration of the above situation, and provides an information medium having magnetic elements and an information detection apparatus capable of detecting multi-bit information accurately and easily by sequentially detecting information from the respective magnetic elements in the information medium.

According to an aspect of the present invention, an information medium includes: a magnetic member having one or plural magnetic elements and a substrate where the plural magnetic elements are arrayed at predetermined intervals in a predetermined direction; and a main body holding the magnetic member.

### BRIEF DESCRIPTION OF THE DRAWINGS

Embodiments of the present invention will be described in detail based on the following figures, wherein:

FIG. 1 is a schematic block diagram showing an example of an information medium and an information detection apparatus for detecting information in the medium, according to the present invention;

FIG. 2A is a plan view of the information medium according to an embodiment of the present invention;

FIG. 2B is a partially enlarged view of FIG. 2A;

FIG. 3A is a plan view of the information medium according to another embodiment of the present invention;

FIG. 3B is a partially enlarged view of FIG. 3A;

FIGS. 4A to 4E illustrate an example of information rewriting in the information medium according to the embodiment shown in FIGS. 3A and 3B;

FIGS. 5A to 5D illustrate an example of generation of a magnetic member (thread);

FIG. 6 is a schematic cross-sectional view showing an example of an image forming apparatus (copier) incorporating the information detection apparatus according to the present invention; and

FIG. 7 is a schematic cross-sectional view showing another example of an image forming apparatus (copier) incorporating the information detection apparatus according to the present invention.

### DETAILED DESCRIPTION OF THE INVENTION

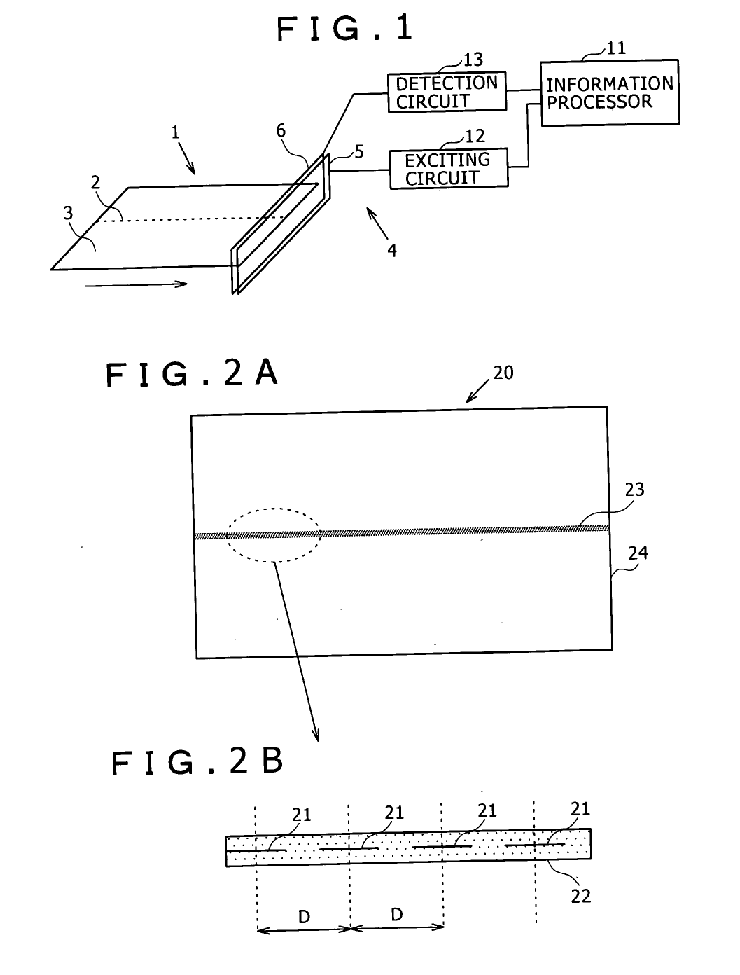

FIG. 1 is a schematic block diagram showing an example of an information medium and an information detection apparatus for detecting information in the medium, according to the present invention. As shown in FIG. 1, an information medium 1 has a magnetic member 2 including one or plural magnetic elements and a substrate where the magnetic elements are arrayed at predetermined intervals in a predetermined direction, and a main body 3 holding the magnetic member 2. In this embodiment, the magnetic member 2 has a thread shape, however, the shape of the magnetic member 2 is not limited to this shape. Further, the main body 3 may be, e.g., a paper sheet, however, not limited to paper but may be a plastic sheet, a label or the like. In a case where the main body 3 is a paper sheet, the magnetic member 2 can be mixed in the paper sheet. An information detection apparatus 4 has an exciting coil 5 and a detection coil 6. An electric current from an exciting circuit 12 is applied to the exciting coil 5 based on a signal from an information processor 11 such as a personal computer (PC). Further, a detection circuit 13 detects an output from the detection coil 6, and transmits the detected output to the information processor 11.

The detection of information is performed as follows. first, the information medium 1 is moved in an arrow direction in the figure such that the one or plural magnetic elements formed in the magnetic member 2 are sequentially passed through the exciting coil 5 and the detection coil 6. The magnetic elements in the magnetic member 2 are excited by the exciting coil 5, and outputs from the excited magnetic elements upon magnetization reversal (e.g., pulse outputs by the large Barkhausen effect) are read by the detection coil 6.

In detection operation, the information processor 11 performs timing control between the exiting circuit 12 and the detection circuit 13. For example, when the exciting circuit 12 applies an electric current of 1 kHz to the exciting coil 5, an alternating field of 1 kHz is generated in predetermined space corresponding to the shape of the exciting coil 5. The information processor 11 detects a time period where a current value is “0” in a rising direction of the 1 kHz current generated in the exciting circuit 12, i.e., a period where the direction of the current is reversed from negative to positive, and outputs a reference signal to the detection circuit 13 once in one cycle of the alternating field in this detected period. The detection circuit 13 inputs the detection signal from the detection coil 6 based on the timing of the reference signal. The detection signal is stored in a storage device (not shown). The information processor 11 eliminates an alternating field component from the detection signal, amplifies a positive signal component in the signal, and eliminates a noise component, thus detects a pulse signal corresponding to the magnetic pulse upon magnetization reversal from the respective magnetic elements. The detected pulse signals are converted to multi-bit information represented with a value “1” or “0”.

In this manner, while the information medium 1 is sequentially moved through the exciting coil 5 and the detection coil 6, outputs from the one or plural magnetic elements formed in the magnetic member 2 are sequentially detected. As the respective magnetic elements correspond to 1 bit, multi-bit information can be easily and accurately read from the information medium 1.

According to the invention, bit information or particularly multi-bit information can be easily and accurately formed in an information medium by adding (or mixing or the like) a magnetic member where one or plural magnetic elements are formed on a substrate to an information medium of paper or the like. The information medium having this arrangement can be utilized for an anti-counterfeit purpose as, e.g., a security paper sheet for prevention of unauthorized duplication. Hereinbelow, the structure and the like of the information medium will be described.

FIG. 2A is a plan view of the information medium according to an embodiment of the present invention. FIG. 2B is a partially enlarged view of FIG. 2A. In the present embodiment, an information medium 20 has a magnetic member 23 including one or plural magnetic elements 21 and a substrate 22 where the magnetic elements 21 are arrayed at predetermined intervals in a predetermined direction, and a paper sheet 24 as a main body holding the magnetic member 23. The magnetic member 23, having a thread shape, will be referred to as a thread 23 hereinafter. As shown in FIG. 2B, in the thread 23, one or plural magnetic elements 21 are arrayed with an interval D therebetween in a predetermined direction on the substrate 22. As the substrate 22, a PET film having a thickness of about 1 to 10 μm, for example, may be used. The magnetic elements 21 of soft wire magnetic material of e.g. Fe—Co amorphous are arrayed with the interval D therebetween on the substrate 22. The magnetic element 21 has a diameter of about 20 μm, a length of about 10 to 30 mm, and has a coercive force less than 10 Oe. The interval D is about 10 to 30 mm. The thread 23 having this arrangement is mixed in the paper sheet 22 when it is manufactured, thus a security paper sheet is obtained. In this manner, one or plural magnetic elements can be easily and accurately arrayed in the paper sheet, and a paper sheet holding multi-bit information can be easily implemented at a low cost.

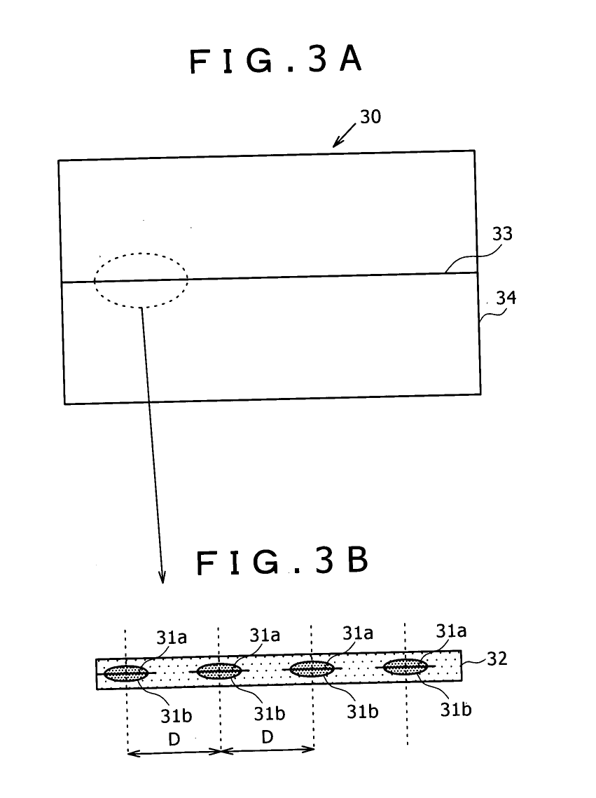

FIG. 3A is a plan view of the information medium according to another embodiment of the present invention. FIG. 3B is a partially enlarged view of FIG. 3A. The difference from the embodiment described in FIG. 2 is that one or plural magnetic elements have different coercive forces. That is, in the present embodiment, an information medium 30 has a magnetic member 33 including two types of respectively one or plural magnetic elements 31a and 31b and a substrate 32 where the magnetic elements 31a and 31b are arrayed at predetermined intervals in a predetermined direction, and a paper sheet 34 as a main body holding the magnetic member 33. The magnetic element 31a as the subject of detection may be made of e.g. Fe—Co amorphous material, and the magnetic element 31b as a bias magnetic field applying device may be made of e.g., ferrite, iron oxide and the like. The magnetic member 33, having a thread shape, will be referred to as a thread 33 hereinafter. As shown in FIG. 3B, in the thread 33, the one or plural magnetic elements 31a and 31b are arrayed with an interval D therebetween in a predetermined direction on the substrate 32. The two types of magnetic elements 31a and 31b have different coercive forces. For example, the coercive force of the magnetic element 31a is less than 10 Oe (e.g., 1 to 2 Oe), while that of the magnetic element 31b is equal to or greater than 10 Oe. The magnetic elements 31a and 31b are arrayed in approximately the same position with the interval D (about 10 to 30 mm) on the substrate 32. The thread 33 having the two types of magnetic elements 31a and 31b and the substrate 32 is placed (e.g. mixed) in the paper sheet 34 when the paper sheet 32 is manufactured, thereby a rewritable security paper sheet can be easily implemented.

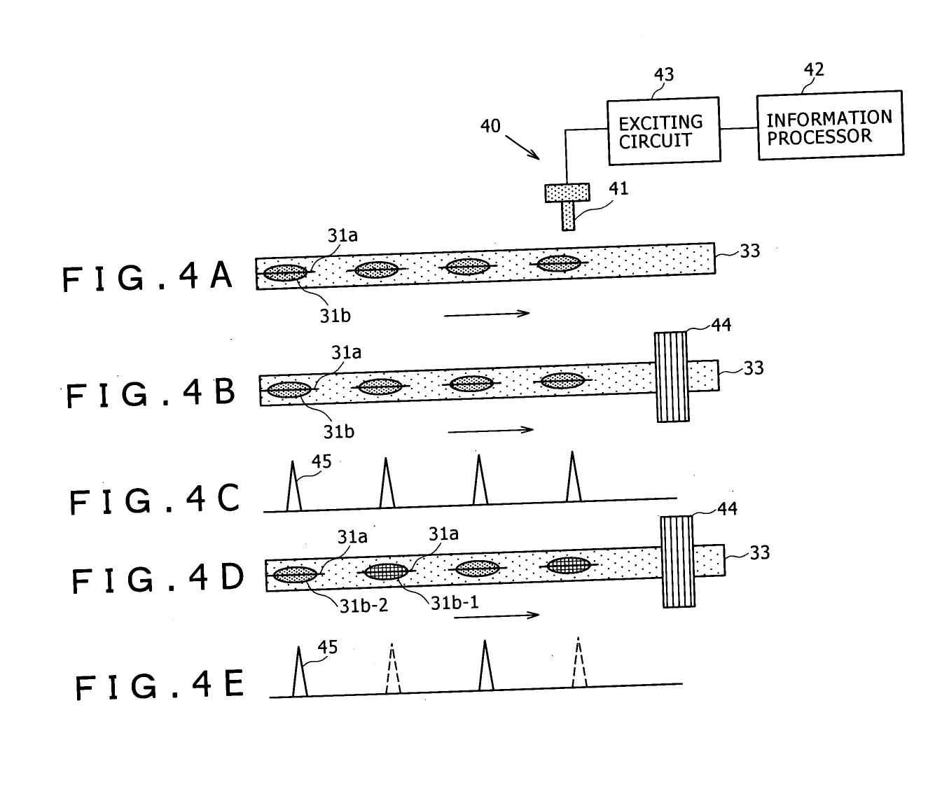

FIGS. 4A to 4E illustrate an example of information rewriting in the information medium according to the embodiment shown in FIGS. 3A and 3B. In this example, an information rewriting apparatus 40 is provided. The information rewriting apparatus 40 may be independently provided of the information detection apparatus or may be provided in the information detection apparatus. The information rewriting apparatus 40 has an electromagnet (magnetic head) 41. The magnetic head 41 is connected to an exciting circuit 43. The exciting circuit 43 applies an electric current to the magnetic head 41 based on a signal from an information processor 42. The information processor 42 controls the timing of application of electric current to the magnetic head 41 in correspondence with the speed of movement of the information medium (paper sheet), the interval between the magnetic elements added to the paper sheet and the like.

When information is recorded, the magnetic head 41 is placed in the portion of the thread 33 in the paper sheet 34 and the paper sheet 34 or the magnetic head 41 is moved such that the thread 33 is passed around the magnetic head 41 as shown in FIG. 4A. In this embodiment, when the magnetic elements 31a and 31b pass through the magnetic head 41, information recording is performed by selecting application of a direct-current magnetic field from the magnetic head 41 to magnetize the magnetic element 31b or application of an alternating magnetic field from the magnetic head 41 to demagnetize the magnetic element 31b.

Next, detection of outputs from the thread 33 where information is recorded as above will be described with reference to FIGS. 4B to 4E. FIG. 4B shows an example where the magnetic head 41 applies an alternating magnetic field to demagnetize the magnetic element 31b. In this case, pulse outputs from all the magnetic elements 31a can be detected by passing the thread 33 around a detection coil (exciting coil and detection coil) 44. FIG. 4C shows a detection signal 45 having bias magnetic field “0” (unmagnetized). Further, FIG. 4D shows an example including the case of magnetization by application of a direct-current magnetic field from the magnetic head 41 to magnetize the magnetic element 31b (31b-1) and the case of demagnetization by application of an alternating magnetic field from the magnetic head 41 to demagnetize the magnetic element 31b (31b-2). Regarding the magnetized magnetic element 31b-1, as an constant magnetic field is always applied to the magnetic element 31a, provided in approximately the same position of the magnetized magnetic element 31b-1, by the coercive force (10 Oe or greater) of the magnetic element 31b, an output from the magnetic element 31a cannot be detected even when it is passed through the exciting detection coil 44. On the other hand, regarding the demagnetized magnetic element 31b-2, an output from the magnetic element 31a provided in approximately the same position of the demagnetized magnetic element 31b-2 can be detected by change of magnetic field when it is passed through the exciting detection coil 44. FIG. 4E shows the detection signal 45 when the bias magnetic field operates. In this manner, information rewriting can be freely performed by magnetizing or demagnetizing the magnetic element 31b by the magnetic head in correspondence with information to be recorded.

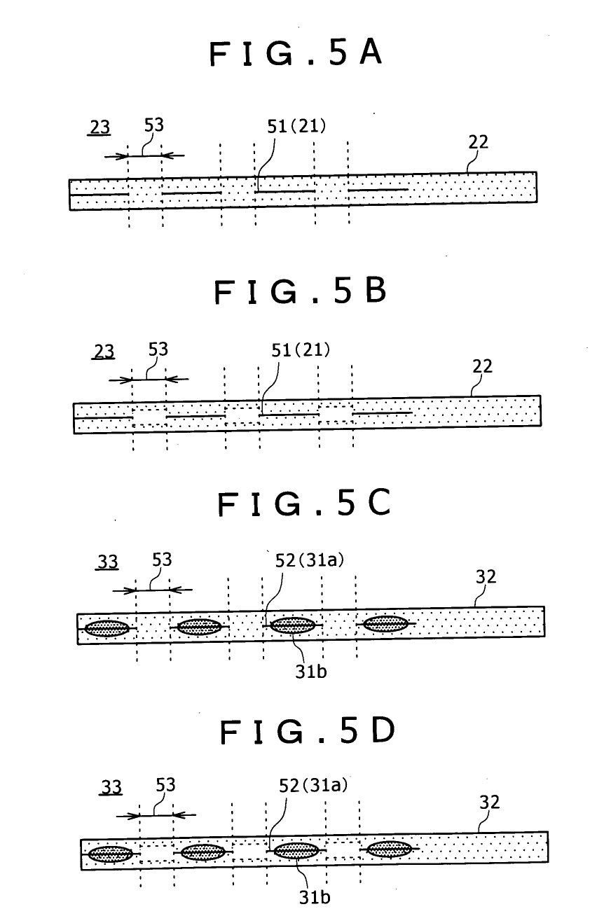

FIGS. 5A to 5D illustrate an example of generation of the magnetic member (thread). The thread 23 in the embodiment shown in FIGS. 2A and 2B is manufactured as follows. As shown in FIG. 5A, one magnetic wire 51 for formation of magnetic element 21 is formed on the substrate 22. Then, one or plural magnetic elements 21 are formed by removing a part 53 of the magnetic wire 51. Otherwise, as shown in FIG. 5B, one magnetic wire 51 for formation of magnetic element 21 is formed on the substrate 22, then one or plural magnetic elements 21 are formed by removing a part 53 of the magnetic wire 51 including a corresponding substrate portion (broken line in the figure). Thus the thread 23 can be manufactured.

Further, the thread 33 in the embodiment shown in FIGS. 3A and 3B is manufactured as follows. As shown in FIG. 5C, one magnetic wire 52 for formation of magnetic element 31a is formed on the substrate 32 where one or plural magnetic elements 31b are formed by evaporation, sputtering or pasting. Then, one or plural magnetic elements 31a are formed by removing a part 53 of the magnetic wire 52. Otherwise, as shown in FIG. 5D, one magnetic wire 52 for formation of magnetic element 31a is formed on the substrate 32 where one or plural magnetic elements 31b are formed as described above, then one or plural magnetic elements 31a are formed by removing a part 53 of the magnetic wire 51 including a corresponding substrate portion (broken line in the figure). Thus the thread 23 can be manufactured.

Further, the thread to be mixed in the paper sheet may be formed by e.g., previously forming the magnetic elements 31b on the substrate 32 by evaporation, sputtering or pasting at predetermined intervals, and sequentially arranging (by pasting with adhesive or the like) the magnetic elements 31a in the areas where the magnetic elements 31b are formed. Otherwise, the rewritable thread can be easily and accurately formed by attaching a substrate 32 where the magnetic elements 31b are formed, to a substrate 32 where the magnetic elements 31a are formed.

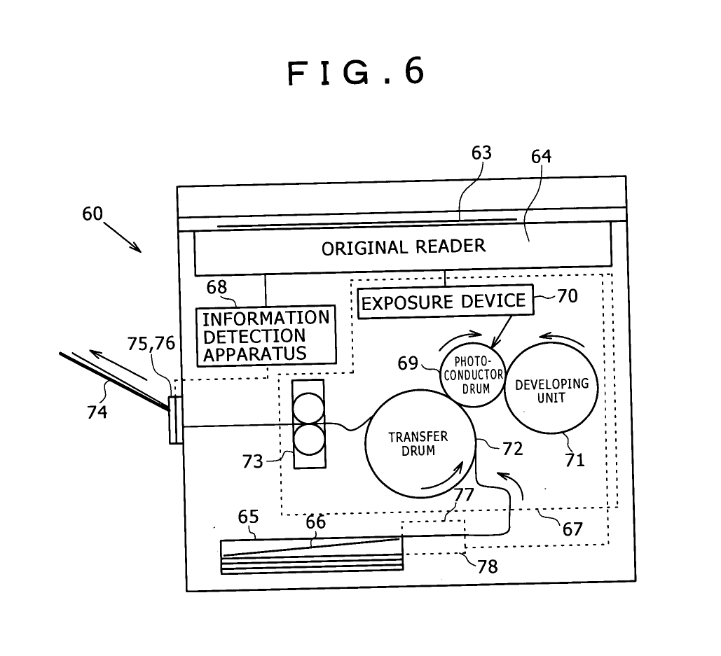

FIG. 6 is a schematic cross-sectional view showing an example of an image forming apparatus (copier) incorporating the information detection apparatus according to the present invention. In this example, the information rewriting by the magnetic head is performed immediately after the information medium (hereinbelow, referred to as a “special sheet”) according to the present invention is supplied from a paper feed tray. The information detection is performed around the exit of a paper discharge tray.

As shown in FIG. 6, a copier 60 has an original reader 64 which reads image information from an original 63 by scanning the original 63 pressed against a platen glass with a platen cover, performs image processing and outputs output image data for print output, an image formation unit 67 (surrounded with an alternate long and short dash line in the figure) which print-outputs image information, corresponding to the output image data from the original reader 64, onto a special sheet 66, and an information detection apparatus 68 which detects unique information from the special sheet 66 on which the image information has been printed. The original reader 64, having e.g. an information processor, is connected to the image formation unit 67 and the information detection apparatus 68. The original reader 64 controls the entire copier 60.

The image formation unit 67 has an exposure device 70 which emits a laser beam to a photoconductor drum 69 in correspondence with the output image data from the original reader 64 and controls scan-exposure of the photoconductor drum 69, a developing unit 71 which develops a latent image formed on the surface of the photoconductor drum 69 by the scan-exposure control by the exposure device 70 with toner in respective colors to form respective color toner images, a transfer drum 72 which transfers the toner images formed on the photoconductor drum 69 by the developing unit 71, and a fixing unit 73 which fixes the toner images transferred on the transfer drum 72 to the special sheet 66 supplied from the paper feed tray 65.

The special sheet 66 stocked in the paper feed tray 65 is provided with unique information. Document management is performed such that the information in the special sheet 66 and the image information printed on the special sheet 66 are associated with each other. The information in the special sheet 66 is represented with at least one type of one or plural magnetic elements corresponding to the information formed in the special sheet 66. The information is detected by the information detection apparatus 68 in the middle of conveyance of the special sheet 66, on which the image information is printed, to a discharge tray 74. More specifically, while the special sheet 66 is moved through an exciting coil 75 and a detection coil 76 provided between the discharge tray 74 and the image formation unit 67, the one or plural magnetic elements arrayed in the special sheet 66 are sequentially excited by the exciting coil 75, and signals sequentially generated from the one or plural magnetic elements by the excitation are detected by the detection coil 76. The information detection apparatus 68 detects the information corresponding to the one or plural magnetic elements included in the special sheet 66 based on the result of detection.

Further, it may be arranged such that a magnetic head 77 is provided in an immediately subsequent position to the paper feed tray 65 so as to rewrite the information in the special sheet 66 by the magnetic head 77 upon paper feeding. The magnetic head 77 is connected to an information rewriting apparatus 78. The information rewriting apparatus 78 can be controlled by the original reader 64, and further, can be incorporated into the information detection apparatus 68.

Next, a processing operation from duplicate-printing of the original 63 by the copier 60 to document management of the image information and the special sheet. 66 where the image information is printed, as associated with each other, will be briefly described. First, a user opens the platen cover of the copier 60, places the original 63 to be duplicated on the platen glass, closes the platen cover, and depresses a copy start button (not shown). Then the original reader 64 scans the original 63 on the platen glass thereby reads image information from the original 63.

The image information read from the original 63 is subjected to image processing and outputted to the exposure device 70 of the image formation unit 67. The exposure device 70 performs scan exposure by emitting a laser beam onto the photoconductor drum 69 based on the output image data from the original reader 64.

The photoconductor drum 69 rotates at a predetermined speed along an arrow direction in the figure by a driving unit (not shown). When the surface of the photoconductor drum 69 has been uniformly charged, an electrostatic latent image corresponding to the output image data is formed on the surface of the photoconductor drum 69 by scan-exposure of a laser beam controlled by the exposure device 70. Then toner images are formed with toner in the respective colors corresponding to the latent image supplied from the developing unit 71. Note that the developing unit 71 has developing materials in yellow (Y), magenta (M), cyan (C), black (K) and the like. The toner images formed on the surface of the photoconductor drum 69 are transferred by an electrostatic force onto the special sheet 66 supplied from the paper feed tray 65 and held on the transfer drum 72. Then the toner images, with the special sheet 66, are transferred to the fixing unit 73 and heat-fixed to the special sheet 66 by the fixing unit 73. In this case, the information in the special sheet 66 can be rewritten by the magnet head 77 based on a signal from the information rewriting apparatus 78 as required.

The special sheet 66, on which the image information of the original 63 is printed through heat fixing, is moved through spaces formed by the exciting coil 75 and the detection coil 76 connected to the information detection apparatus 68 on the way to the discharge tray 74. At this time, one or plural magnetic elements corresponding to the information formed in the special sheet 66 are magnetized by a predetermined alternating field from the exciting coil 75, then steep magnetic pulses emitted upon magnetization reversal are detected via the detection coil 76. Then the information detection apparatus 68 detects identification information of the special sheet 66 based on the result of detection.

The information detected by the information detection apparatus 68 is outputted to the original reader 64. The original reader 64 associates the information of the special sheet 66 read by the information detection apparatus 68 with the image information of the original 63 read by the original reader 64 and stores them into a database (not shown), thus conducts document management. By using the copier 60 operating as above, document management can be made with association between the image information of the original 63 and the information of the special sheet 66 on which the image information is printed. Further, it may be arranged such that when the original under the document management is duplicated by the copier 60, the copier 60 determines whether or not the original can be duplicated based on the information attached to the original, and if it is determined that the original cannot be duplicated, the copier performs a duplication prohibition operation. In this arrangement, the leakage of confidential information by inadvertent duplication or the like can be prevented.

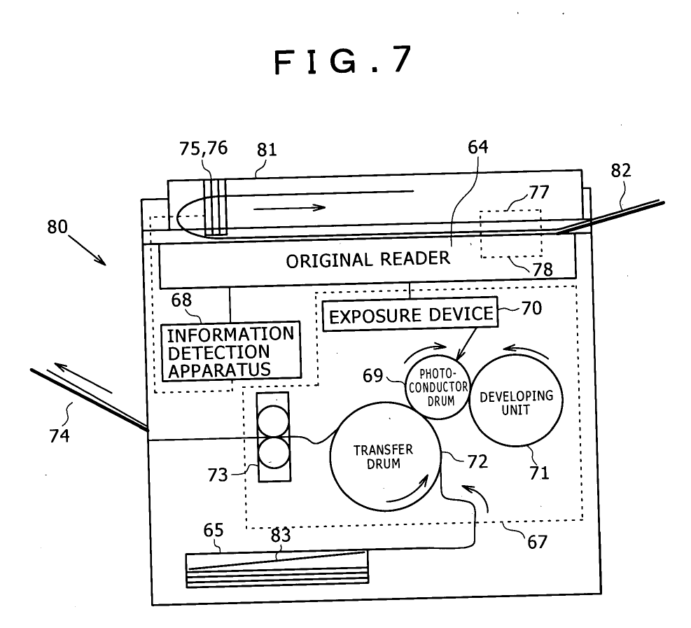

FIG. 7 is a schematic cross-sectional view showing an another example of an image forming apparatus (copier) incorporating the information detection apparatus according to the present invention. In this example, the information rewriting by the magnetic head and the information detection are performed in a paper passage in an auto document feeder (ADF). As the other operations are the same as those in the example in FIG. 6, the difference will be described hereinbelow. As shown in FIG. 7, a copier 80 has an ADF 81. The ADF 81 includes the magnetic head 77 connected to the information rewriting apparatus 78, and the exciting coil 75 and the detection coil 76 connected to the information detection apparatus 68 on the downstream of the magnetic head 77. In this example, a special sheet 82 is transferred as a duplication original by using the ADF 81, and information rewriting is performed by the magnetic head 77 in accordance with necessity, and further, image information is read by the original reader 64, and information in the special sheet 82 is detected by the exciting coil 75 and the detection coil 76. The detected information is outputted to the original reader 64 via the information detection apparatus 68. The original reader 64 determines whether or not the original can be duplicated based on the information, and if it is determined that the original can be duplicated, it print-outputs the image information of the special sheet 82 on a print sheet 83, while if it is determined that the original cannot be duplicated, it prohibits the print processing operation. In this arrangement, the leakage of confidential information by inadvertent duplication or the like can be prevented.

As described above, according to the embodiments, an information medium having unique information is formed for prevention of counterfeiting by unauthorized duplication of securities and the like, for prevention of the leakage of information such as confidential information, personal information and the like, or for document management, and the information medium is applied to a printer, a copier and the like. As a paper sheet on which information is printed or duplicated, a special sheet provided with unique information is employed. As the information of the special sheet and the information printed or duplicated on the special sheet are associated and managed, a printer or the like capable of document management can be implemented.

Further, when the managed confidential information printed on the special sheet, securities or the like are to be duplicated by using a copier or the like provided with the information detection apparatus according to the present invention, the information detection apparatus detects information in the special sheet on which confidential information or the like is printed, or information provided to the securities or the like, and performs a duplication prohibition operation or the like based on the detected information. Thus unauthorized duplication of confidential information, securities or the like can be prevented, and the prevention of leakage of information, security protection, prevention of counterfeiting and the like can be attained.

The present invention relates to an information medium having magnetic elements and an information detection apparatus, and more particularly, to an information medium where one or plural magnetic elements are arrayed at predetermined intervals and an information detection apparatus, which provides possibility of industrial applicability.

As described above, in the embodiment of this invention, an information medium includes: a magnetic member having one or plural magnetic elements and a substrate where the plural magnetic elements are arrayed at predetermined intervals in a predetermined direction; and a main body holding the magnetic member. The one or the plural magnetic elements may include one or plural first magnetic elements having a first coercive force and one or plural second magnetic elements having a second coercive force greater than the first coercive force. In this case, the first magnetic element and the second magnetic element may be provided in approximately the same position in the substrate.

Further, the one or the plural magnetic elements may be formed by removing a part of a magnetic wire for formation of the magnetic elements formed on the substrate. Alternatively, the one or plural magnetic elements may be formed by removing a part of a magnetic wire for formation of the magnetic elements formed on the substrate with a portion of the substrate corresponding to the part. Further, the one or the plural first magnetic elements may be formed by removing a part of a magnetic wire for formation of the first magnetic elements formed on the one or the plural second magnetic elements on the substrate. Alternatively, the one or the plural first magnetic elements may be formed by removing a part of a magnetic wire for formation of the first magnetic elements formed on the one or the plural second magnetic elements on the substrate with a portion of the substrate corresponding to the part.

Further, the main body may be paper. In this case, the magnetic member may be mixed in the paper. Further, the main body may be a plastic sheet or a label.

Further, in the embodiment of this invention, an information detection apparatus includes: an exciting coil that moves relatively to the information medium to sequentially excite the one or the plural magnetic elements arrayed in the information medium; and a detection coil that detects signals generated by the excitation. For the relative movement, at least one of the information medium or the coil moves. The movement is made in the same way in the following arrangements. Further, the present invention provides an information detection apparatus including: an information rewriting unit that arbitrarily magnetizes or demagnetizes the one or the plural second magnetic elements arrayed in the information medium; an exciting coil that moves relatively to the information medium to sequentially excite the one or the plural first magnetic elements arrayed in the information medium; and a detection coil that detects signals generated by the excitation.

Further, in the embodiment of this invention, an information rewriting and detection apparatus includes: an information rewriting apparatus that arbitrarily magnetizes or demagnetizes the one or the plural second magnetic elements arrayed in the information medium; and an information detection apparatus having an exciting coil that moves relatively to the information medium to sequentially excite the one or the plural first magnetic elements arrayed in the information medium and a detection coil that detects signals generated by the excitation.

Further, in the embodiment of this invention, an image forming apparatus, having an original reader and an exposure unit, for forming an image on the information medium, includes: an information rewriting apparatus that arbitrarily magnetizes or demagnetizes the one or the plural second magnetic elements arrayed in the information medium; and an information detection apparatus having an exciting coil that moves relatively to the information medium to sequentially excite the one or the plural first magnetic elements arrayed in the information medium and a detection coil that detects signals generated by the excitation.

As described above, an embodiment of the present invention provides an information medium and an information detection apparatus capable of detecting multi-bit information accurately and easily by sequentially detecting information from respective magnetic elements in the information medium. According to another embodiment of the present invention, a thin-plate substrate such as a PET film is used, and a magnetic member (thread) where magnetic elements are arrayed on the substrate is attached to (e.g., mixed in) an information medium such as a paper sheet. In this arrangement, one or plural magnetic elements can be easily and precisely arrayed in the information medium, and the information medium holding bit information or multi-bit information can be realized easily and at a low cost. Further, in a case where a thread where two types of magnetic elements are formed is attached to the information medium, an information medium which is rewritable and which can be used in printing or duplication can be easily implemented.

While this invention has been described in connection with certain embodiments, it is to be understood that the subject matter encompassed by way of this invention is not to be limited to those specific embodiments. On the contrary, it is intended for the subject matter of the invention to include all alternative, modification and equivalents as can be included within the spirit and scope of the following claims.

The entire disclosure of Japanese Patent Application No. 2004-273458 filed on Sep. 21, 2004 including specification, claims, drawings and abstract is incorporated herein by reference in its entirety.

What is claimed is:

1. An information medium comprising:
a magnetic member having one or a plurality of magnetic elements and a substrate where the plurality of magnetic elements are arrayed at predetermined intervals in a predetermined direction; and
a main body holding the magnetic member.

2. The information medium according to claim 1, wherein the one or the plurality of the magnetic elements include one or a plurality of first magnetic elements having a first coercive force and one or a plurality of second magnetic elements having a second coercive force greater than the first coercive force.

3. The information medium according to claim 2, wherein the first magnetic element and the second magnetic element are provided in approximately the same position in the substrate.

4. The information medium according to claim 1, wherein the one or the plurality of the magnetic elements are formed by removing a part of a magnetic wire for formation of the magnetic elements formed on the substrate.

5. The information medium according to claim 1, wherein the one or the plurality of the magnetic elements are formed by removing a part of a magnetic wire for formation of the magnetic elements formed on the substrate with a portion of the substrate corresponding to the part.

6. The information medium according to claim 2, wherein the one or the plurality of the first magnetic elements are formed by removing a part of a magnetic wire for formation of the first magnetic elements formed on the one or the plurality of the second magnetic elements on the substrate.

7. The information medium according to claim 2, wherein the one or the plurality of the first magnetic elements are formed by removing a part of a magnetic wire for formation of the first magnetic elements formed on the one or the plurality of the second magnetic elements on the substrate with a portion of the substrate corresponding to the part.

8. The information medium according to claim 1, wherein the main body is paper.

9. The information medium according to claim 8, wherein the magnetic member is mixed in the paper.

10. The information medium according to claim 1, wherein the main body is a plastic sheet or a label.

11. An information detection apparatus comprising:
an exciting coil that moves relatively to the information medium in claim 1 to sequentially excite the one or the plurality of the magnetic elements arrayed in the information medium; and
a detection coil that detects signals generated by the excitation.

12. An information detection apparatus comprising:
an information rewriting unit that arbitrarily magnetizes or demagnetizes the one or the plurality of the second magnetic elements arrayed in the information medium in claim 2;
an exciting coil that moves relatively to the information medium to sequentially excite the one or the plurality of the first magnetic elements arrayed in the information medium; and
a detection coil that detects signals generated by the excitation.

13. An information rewriting and detection apparatus comprising:
an information rewriting apparatus that arbitrarily magnetizes or demagnetizes the one or the plurality of the second magnetic elements arrayed in the information medium in claim 2; and
an information detection apparatus having an exciting coil that moves relatively to the information medium to sequentially excite the one or the plurality of the first magnetic elements arrayed in the information medium and a detection coil that detects signals generated by the excitation.

14. An image forming apparatus, having an original reader and an exposure unit, for forming an image on the information medium in claim 2, comprising:
an information rewriting apparatus that arbitrarily magnetizes or demagnetizes the one or the plurality of the second magnetic elements arrayed in the information medium; and
an information detection apparatus having an exciting coil that moves relatively to the information medium to sequentially excite the one or the plurality of the first magnetic elements arrayed in the information medium and a detection coil that detects signals generated by the excitation.
